(19) United States
(12) Patent Application Publication
(10) Pub. No.: US 2017/0029606 A1
(43) Pub. Date: Feb. 2, 2017

(54) METHOD OF MAKING A TIRE SEALANT

(71) Applicant: THE GOODYEAR TIRE & RUBBER COMPANY, Akron, OH (US)

(72) Inventors: Gabor KASZAS, Akron, OH (US); Michael Joseph RACHITA, Canton, OH (US)

(21) Appl. No.: 14/813,752

(22) Filed: Jul. 30, 2015

(51) Int. Cl. C08L 19/00

(52) U.S. Cl. CPC C08L 19/00

(57) ABSTRACT

The present invention is directed to a method of making a tire sealant, the method comprising the steps of: mixing a first mixture of 100 parts by weight of bromobutyl rubber with from 100 to 900 parts by weight of polybutene to make a first mixture; and mixing the first mixture with 0.5 to 10 parts by weight of a nucleophile to make a tire sealant.

### BACKGROUND

Various methods, sealants and tire constructions have been suggested for pneumatic tires relating to the use of liquid sealant coatings in which the sealant flows into a puncture hole. However, such liquid sealants can flow excessively at elevated temperatures and cause the tire to become out of balance. Also, the liquid sealant may not be entirely operable or effective over a wide temperature range extending from summer to winter conditions. More complicated tire structures which encase a liquid sealant in a vulcanized rubber material can be expensive to manufacture and can also create balance and suspension problems due to the additional weight required in the tire.

Puncture sealing tires also have been further proposed wherein a sealant layer of degradable butyl based rubber, for example, is assembled between unvulcanized tire layers to provide a built-in sealant. By laminating the sealant layer between two or more non-degraded rubber layers, e.g., the tire inner liner and a tire carcass, the sealant layer retains its structural integrity during the vulcanization operation where high pressures are applied to the tire, which would otherwise displace the degraded rubber layer from its desired location. However, the compounds that typically are used in the built-in sealant, e.g., organic peroxide depolymerized butyl based rubber, can generate gases at higher temperature, such as during the tire cure or during tire use, which can result in aesthetically unappealing inner liner blister formation. Aside from being unappealing, such blister formation may allow the sealant to unfavorably migrate away from its intended location. To combat blister formation, the inner liner, for example, can be provided at an increased thickness but this can add to the cost of building a tire.

It is also known to directly apply sealant layers to tires after the cure process, or post cure. Such sealant layers generally are adhesively secured to the exposed surface of the innermost inner liner, and may be tacky and gel-like. Such post cure sealants as known in the art may not provide adequate long term seal against puncturing objects such as nails and the like.

Accordingly, there is a need for an improved post cure sealant layer for tires.

### SUMMARY

The present invention is directed to a method of making a tire sealant, the method comprising the steps of: mixing a first mixture of 100 parts by weight of bromobutyl rubber with from 100 to 900 parts by weight of polybutene to make a first mixture; and mixing the first mixture with 0.5 to 10 parts by weight of a nucleophile to make a tire sealant.

### DRAWINGS

FIG. 1 shows a cross-sectional view of a pneumatic tire which contains a circumferential sealant layer which contains a post tire cure applied sealant layer adhered to the innerliner.

FIG. 2 shows a partial cross-sectional view of a portion of the tire with a post-tire cure applied sealant layer.

### DESCRIPTION

There is disclosed a method of making a tire sealant, the method comprising the steps of: mixing a first mixture of 100 parts by weight of bromobutyl rubber with from 100 to 900 parts by weight of polybutene to make a first mixture; and mixing the first mixture with 0.5 to 10 parts by weight of a nucleophile to make a tire sealant.

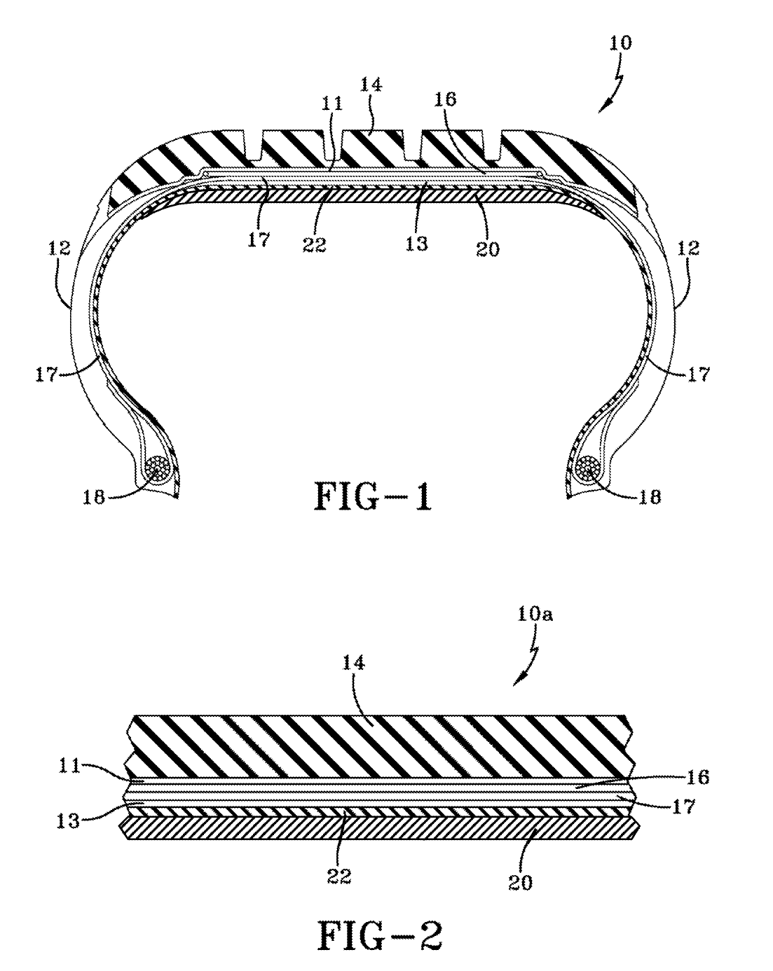

In FIG. 1, a cross-section of a cured pneumatic tire 10 is presented comprised of a tread 14 which includes a tread base rubber layer 11, sidewalls 12, spaced apart beads 18 and carcass underlying the tread 14 (including the tread base layer 11), comprised of cord reinforced (e.g. wire cord reinforced) rubber belt plies 16, cord reinforced (e.g. synthetic nylon or polyester cord reinforced) rubber carcass ply 17 and an optional rubber barrier layer 13 with inner liner rubber layer 22 being positioned radially inward of the carcass and optional barrier layer 13 and carcass ply 17 together with a sealant layer 20 forming the radially innermost surface of the tire. The sealant layer is composition comprising an ionomer and a diluent.

The sealant layer includes a bromobutyl rubber. Bromobutyl rubber includes brominated copolymers of C₄ to C₇ isoolefins with C₄ to C₁₄ conjugated dienes and optionally other co-polymerizable monomers. In one embodiment, the bromobutyl rubber is a brominated copolymer of isoprene and isobutylene.

The sealant also includes a nucleophile. Nitrogen or phosphorus nucleophiles includes compounds of formula I

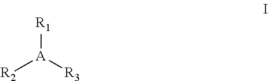

where A is a nitrogen or phosphorus; and R₁, R₂ and R₃ are selected from the group consisting of linear or branched C₁-C₁₈ alkyl substituents, an aryl substituent which is monocyclic or composed of fused C₄-C₈ rings, and/or a hetero atom selected from, for example, B, N, O, Si, P, and S.

In general, the appropriate nucleophile will contain at least one neutral nitrogen or phosphorus center which possesses a lone pair of electrons which is both electronically and sterically accessible for participation in nucleophilic substitution reactions. Suitable nucleophiles include trimethylamine, triethylamine, triisopropylamine, tri-n-butylamine, trimethylphosphine, triethylphosphine, triisopropylphosphine, tri-n-butylphosphine, and triphenylphosphine.

Other suitable nucleophiles include substituted azoles as disclosed in US 2012/0157579. In one embodiment, the nucleophile may be N-butyl imidazole, N-(trimethylsilyl)imidazole, N-decyl-2-methylimidazole, N-hydroxyethyl imidazole, N-(3-trimethoxysilylpropyl)imidazole, N-vinylimidazole, 2-(imidazol-1-yl)ethyl 2-methyl-2-propenoate, 1-butylbenzimidazole, or a combination thereof.

The amount of nucleophile added to make the sealant may be in the range from 0.1 to 1.5 molar equivalents, more preferably 0.15 to 1.0 molar equivalents based on the total molar amount of allylic halide present in the bromobutyl polymer. In one embodiment, the amount of nucleophile added ranges from 0.5 to 10 parts by weight, per 100 parts by weight of bromobutyl rubber (phr).

The sealant also includes a polybutene. By polybutene, it is meant a polymer of one or more butene isomers including 1-butene, 2-butene, and 2-methylpropene (isobutylene). The polybutene may be commercially referred to as polyisobutylene.

Such polybutenes preferably have a number average molecular weight exceeding about 1000 to minimize the possibility of migration from the sealant layer into adjacent tire components. It is preferably prepared by polymerizing an isobutylene rich stream with a metal halide catalyst and preferably has a polymer backbone structure resembling polyisobutylene. Very suitable polybutenes are available under the trademark Indopol In one embodiment, the number average molecular weights (Mn) of the polybutene from about 1000 to about 2500, as determined by vapor pressure osmometry.

The polybutene is added to the sealant in an amount ranging from 100 to 900 parts by weight, per 100 parts by weight of bromobutyl rubber (phr). In one embodiment, the polybutene is present is an amount ranging from 200 to 600 parts by weight, per 100 parts by weight of bromobutyl rubber.

Oils may be included in the sealant as a viscosity modifier. Suitable oils include oils such as mineral oils including but not limited to aromatic oils, naphthenic oils, paraffinic oils, MES oils, TDAE oils, RAE oils, and SRAE oils, and vegetable oils including but not limited to sunflower oil, soybean oil, corn oil, castor oil, and canola oil.

Resins may also be included in the sealant as a tackifier. Suitable resin include hydrocarbon resins, phenol/acetylene resins, rosin derived resins and mixtures thereof. Representative hydrocarbon resins include coumarone-indene-resins, petroleum resins, terpene polymers and mixtures thereof. Phenol/acetylene resins may be derived by the addition of acetylene to butyl phenol in the presence of zinc naphthlate. Additional examples are derived from alkylphenol and acetylene.

The sealant composition may be cured by crosslinking during the mixing process in order to achieve additional structural strength of the composition. This can be achieved by crosslinking the allylic halide units which have not been converted to ionomeric units. Alternatively it is possible to add small amounts of regular butyl to the composition with the purpose of providing additional crosslink points to adjust the viscosity of the composition.

There are numerous cure system available to crosslink the remaining allylic halide units of the ionomer. These are crosslinking them by sulfur alone, magnesium oxide, by the use of ZnO in combination of a fatty acid such as stearic acid, by peroxide alone such as dicumyl peroxide or using peroxide in combination with multifunctional coagents, such as 1,3 butylene glycol dimethylacrylate, zinc diacrylate, trimethylol propane trimethacrylate, triallyl trimesate, N,N′-m-phenylenedimaleimide. Crosslinking of allylic halide units can also be achieved by the use of primary or secondary aliphatic or aromatic amines or primary or secondary amine containing trialkoxy silanes, such as gamma-aminopropyl-triethoxysilane. It is also known to the art that higher degree of state of cure can be achieved by the combination of ZnO with aromatic amines such as diphenylamine, diphenyl-p-phenylenediamine, p-octyldiphenylamine, and the low temperature addition product of diphenylamine and acetone. It is also known that the crosslinking of the bromobutyl can be achieved by the use of bifunctional dienophyles alone such as N,N′-m-phenylenedimaleimide.

Other conventional compounding ingredients may be included in the mixing process, including but not limited to filler such as carbon black, silica, or calcium carbonate, antidegradants, colorants, and the like.

Reaction of the nucleophile with the bromobutyl rubber may be accomplished for example by combining the nucleophile and rubber in a rubber mixer such as a Brabender internal mixer, conical mixer, extruder, or the like. The bromobutyl polymer and the nucleophile can be reacted for about 10 to 90 minutes, preferably from 15 to 60 minutes and more preferably from 20 to 30 minutes at temperatures ranging from 80 to 200° C., preferably from 100 to 180° C. and more preferably from 140 to 160° C. Following reaction and curing, the sealant composition is applied to the innerliner of a cured tire. A suitable process for mixing the sealant and applying to a tire innerliner is as disclosed in U.S. Pat. No. 8,821,982.

In one embodiment, the polybutene is added to the bromobutyl rubber and mixed prior to addition of the nucleophile. In this way, adequate blending of the brromobutyl rubber and polybutene may be achieved before reaction of the bromobutyl rubber with the nucleophile. In one embodiment, a fraction of the polybutene is mixed with the bromobutyl rubber before addition of the nucleophile, and the remainder of the polybutene is mixed after addition of the nucleophile. In one embodiment, a major portion (more than half) of the polybutene is mixed with the bromobutyl rubber prior to addition of the nucleophile. In one embodiment, from 60 to 90 percent of the polybutene is mixed with the bromobutyl rubber prior to addition of the nucleophile, and the remaining polybutene is mixed after addition and mixing of the nucleophile.

FIG. 2 depicts a partial cross-section of the sulfur cured pneumatic tire 10, labeled as 10a in FIG. 2, comprising the tire tread 14 with its tread base rubber layer 11, wire cord reinforced rubber belt plies 16, carcass with synthetic cord reinforced rubber carcass ply 17 (e.g. synthetic fiber based cord such as, for example, nylon or polyester cord), optional rubber barrier layer 13, rubber inner liner 22 and sealant layer 20. The sealant layer 20 is applied to the inner liner 22 of the already cured tire (and is therefore a post tire cure applied sealant layer) to provide a tire with a sealant layer with puncture sealing properties against various puncturing objects.

The thickness of the circumferential sealant layer 20 can vary depending somewhat upon the degree of sealing ability desired as well as the tire itself, including the tire size and intended tire use. For example, the thickness of the sealant layer may range from about 0.13 cm (0.05 inches) to about 1.9 cm (0.75 inches) depending somewhat upon the tire itself and its intended use. For example, in passenger tires, the sealant layer 20 might, for example, have a thickness in a range of about 0.33 cm (0.125 inches) whereas for truck tires, the sealant layer 20 might, for example, have a thickness in a range of about 0.76 cm (0.3 inches). The post cured tire applied wsealant layer 20 is generally situated in the crown region of the tire 10, and, if desired, may include colorant so that it is of a non-black color that may contrast with the black colored inner liner, tread, or sidewall so that a tire puncture can be noticed.

The tire inner liner rubber layer 22 may be comprised of a conventional sulfur curable rubber inner liner for use in pneumatic tires. In one example, the rubber innerliner 22 can be a sulfur curative-containing bromobutyl rubber composition of a bromobutyl rubber such as for example chlorobutyl rubber or bromobutyl rubber. Such bromobutyl rubber based inner liner layer may also contain one or more sulfur curable diene-based elastomers such as, for example, c is 1,4-polyisoprene natural rubber, c is 1,4-polybutadiene rubber and styrene/butadiene rubber, or mixtures thereof. The inner liner 22 is normally prepared by conventional calendering or milling techniques to form a strip of uncured compounded rubber of appropriate width. When the tire 10 is cured, the inner liner 22 becomes co-cured and thereby integral with, the tire 10. Tire inner liner rubber layers and their methods of preparation are well known to those having skill in such art.

### Example

In this example, the effect of a sealant composition on the ability to seal a puncture in a rubber sample is illustrated. A sealant composition was mixed in a 60 liter conical twin mixer (Colmec CTM-95) with amounts given in Table 1 in phr based on the amount of bromobutyl rubber. The addition sequence is also indicated in Table 1. Bromobutyl rubber was first mixed with magnesium oxide, calcium carbonate and a majority of the polybutene, followed by addition of the triphenyl phosphine and finally the remainder of the polybutene. In the mixer, the diathermic unit was set at 40° C. at start. The batch temperature was kept in the range 105 to 110° C. from the end of the bromobutyl rubber breakdown until the start of the addition of the polybutene. The temperature was then lowered to 85-90° C. and kept in this range by the adjustment of rotor speed.

TABLE 1

| | |
|---|---|
| Amount | Addition |

| | (kg) | (phr) | Sequence |
|---|---|---|---|
| Bromobutyl 2222 | 18.28 | 100 | 1 |
| Magnesium oxide | 0.58 | 3.2 | 2 |
| Calcium Carbonate | 5.80 | 31.7 | 2 |
| Polybutene¹ | 5.80 | 31.7 | 2 |
| Polybutene¹ | 26.50 | 145 | 3 |
| Triphenyl Phosphine² | 0.59 | 3.2 | 4 |
| Polybutene¹ | 7.45 | 40.8 | 5 |

¹Polyisobutylene as Indopol H-300 from Ineos. Mₙ = 1,300 g/mol.
²Triphenyl phosphine pellets from BASF

### Results of the Sealability Test Conducted at Room Temperature.

A series of holes of various diameter were drilled into a cured rubber mat consisting of sequential layers of tread compound, reinforcement material, and innerliner compound, each layer being 2 mm thick. The rubber mat was cooled with liquid nitrogen before holes with diameters of 1 mm, 2 mm and 3 mm were drilled. Cured sealant compound was dispensed on silicon coated paper which was then cut to the required sample size and transferred to the rubber mat, followed by removal of the paper. Nails with diameter of 5 mm were inserted in the pre-drilled holes. The sample was then pressurized to 2.5 bars, followed by removal of the nails. The holes were then visually inspected immediately after nail removal and 20 hours after nail removal, with results as given in Tables 2 and 3 below.

Samples were cured in a press for 30 minutes at 160° C.

TABLE 2

| Status immediately after nail removal | | | | Status 20 hours after nail removal | | | |
|---|---|---|---|---|---|---|---|
| | Hole # | Hole # | Hole # | | Hole # | Hole # | Hole # |
| | 1 | 2 | 3 | | 1 | 2 | 3 |
| Hole | sealed | sealed | sealed | Hole | sealed | sealed | sealed |
| 1 mm | | | | 1 mm | | | |
| Nail | | | | Nail | | | |
| 5 mm | | | | 5 mm | | | |
| Hole | sealed | sealed | sealed | Hole | sealed | sealed | sealed |
| 2 mm | | | | 2 mm | | | |
| Nail | | | | Nail | | | |
| 5 mm | | | | 5 mm | | | |
| Hole | sealed | sealed | sealed | Hole | sealed | sealed | sealed |
| 3 mm | | | | 3 mm | | | |
| Nail | | | | Nail | | | |
| 5 mm | | | | 5 mm | | | |

As seen in Table 2, the sealant successfully sealed all of the nail holes in the test substrate.

1. A method of making a tire sealant, the method comprising the steps of:
mixing a first mixture of 100 parts by weight of bromobutyl rubber with from 100 to 900 parts by weight of polybutene to make a first mixture;
mixing the first mixture with 0.5 to 10 parts by weight of a nucleophile to make a tire sealant; and
applying the tire sealant to a pneumatic tire, wherein the pneumatic tire comprises a radially outer circumferential rubber tread disposed on a supporting carcass, an inner liner rubber layer radially inwardly disposed on the supporting carcass, and the tire sealant is applied as a sealant layer adhered to and disposed inwardly of the rubber inner liner layer as a radially inner surface of the tire;
wherein from 60 to 90 percent of the polybutene is added during mixing to make the first mixture, and the remainder of the polybutene is added in a mixing step after mixing the nucleophile with the first mixture.

2. (canceled)

3. The method of claim 1, wherein the nucleophile is of formula (I) 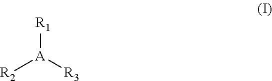
where A is a nitrogen or phosphorus; and R₁, R₂ and R₃ are selected from the group consisting of linear or branched C₁-C₁₈ alkyl substituents, an aryl substituent which is monocyclic or composed of fused C₄-C₈ rings, and/or a hetero atom selected from, for example, B, N, O, Si, P, and S.

4. The method of claim 1, wherein the polybutene has a number average molecular weight Mₙ ranging from 1,000 to 2,500.

5. The method of claim 1, wherein a major portion of the polybutene is added during mixing to make the first mixture, and a minor portion of the polybutene is added in a mixing step after mixing the nucleophile with the first mixture.

6. (canceled)

7. The method of claim 1, wherein the nucleophile is an azole.

8. The method of claim 1, wherein the nucleophile is an azole is selected from the group consisting of N-butyl imidazole, N-(trimethylsilyl)imidazole, N-decyl-2-methylimidazole, N-hydroxyethyl imidazole, N-(3-trimethoxysilylpropyl)imidazole, N-vinylimidazole, 2-(imidazol-1-yl)ethyl 2-methyl-2-propenoate, 1-butylbenzimidazole, or a combination thereof.
